(19) United States
(12) Patent Application Publication
(10) Pub. No.: US 2004/0210896 A1
(43) Pub. Date: Oct. 21, 2004

(54) Distributed interactive media authoring and recording

(76) Inventors: Charles C.L. Chou, Kailua, HI (US); Andrew Jeffrey Crilly, Cupertino, CA (US); Annie Myong Hae Chan, Los Altos, CA (US)

Correspondence Address: Peter G. Mikhail, SIDLEY AUSTIN BROWN & WOOD LLP, Suite 5000, 555 California Street, San Francisco, CA, 94104-1715, US

(21) Appl. No.: 10/420,622

(22) Filed: Apr. 21, 2003

(51) Int. Cl. G06F 9/445

(52) U.S. Cl. 717/174; 717/120; 717/163

(57) ABSTRACT

Interactive media such as a DVD can be created in more than one location. The editing of the content into chapters and the creation of menus that can access the content can be created at one location, and information regarding the menus and the chapters can then be transmitted to a second location and the DVD or other media can be recorded at the first or second location. A software driven system controls, accelerates and simplifies the process.

### CROSS REFERENCE

This patent is related to U.S. patent application Ser. No. 10/295,372, entitled “Editing System and Software for Automatically Creating Interactive Media”, and filed on Nov. 14, 2002, which is hereby incorporated by this reference in its entirety. An appendix is submitted on a compact disc according to 37 CFR 1.52 containing the following files, each of which is hereby incorporated by this reference in its entirety: config.ini; dir.txt.; 02074.oce; and OMTwrite.cfg.

### BACKGROUND OF THE INVENTION

1. Field of the Invention

The present invention relates generally to editing systems and software, and more specifically to a distributed editing and distribution system for DVDs and other media.

2. Related Art

The design and production of interactive multi-media materials is a labor intensive and therefore expensive process. In general, each application for making multi-media materials is custom designed to meet specific requirements of the product.

One way to make interactive multi-media titles such as DVDs involves the use of sophisticated editing machinery and techniques generally used to master full length feature films on DVD. While the flexibility such systems afford allows for the inclusion of custom features, the time, effort, financial investment, and most of all the skill level necessary to use this type of set-up is prohibitive for all but large production houses and the like. To create a feature length film or other title on DVD requires a team of specialized people each skilled in a small subset of the process, such as graphic artists and designers, video editors, production specialists and production managers etc . . . Likewise, creating any other content on DVD using the same equipment has the same requirements.

One of the main challenges in any multimedia business is the delivery of the multimedia content. In order to have content to deliver, one must also first have access to desirable content.

Of the many delivery options, disc based content delivery today still proves to be the most reliable, high quality and cost effective. However, with disc based content delivery one must also solve the additional challenge of disc replication and distribution. It will be most desirable if a high quality, low cost disc can be made-to-order, ready in a short period of time, and made or available in a convenient location.

With the advent of recordable DVD media known as the DVD−R (or the new DVD+R), low volume, made-to-order type of DVD content is now possible and quite popular. However, due to the high cost of authoring individual discs, the typical use of DVD−r's in such a made-to-order application is limited. Although computer users can copy material to DVD, they cannot create interactive titles including pushbutton menus, and also cannot easily access desirable content.

A wide variety of multimedia applications and environments can be enhanced with interactive content, and thus the demand for DVDs and other interactive formats is rapidly growing. Many more traditional environments, such as the field of education, for instance, greatly benefit from dynamic interactive presentations that allow choice during presentation and tailor the experience to the audience. In these environments, the resources available for making an interactive title are substantially less than those for making a full-length feature movie or television series DVD. Additionally, some of these other environments may have other unique needs that are not currently met with the prior authoring systems.

Other ways to make interactive multi-media titles involve the usage of more convenient software packages on personal computers. These computer packages generally offer less flexibility but are easier to use and streamline the process. However, each of these prior computer packages has its own limitations and drawbacks.

One approach taken in prior packages is the use of templates. These templates provide a convenient yet relatively rigid starting point for the process, tend to be simplistic, and provide only a small number of features that can be routinely incorporated.

This, and other prior approaches and solutions are limited in terms of content, format, layout and ease of use etc . . .

### SUMMARY OF THE INVENTION

The present invention greatly simplifies the creation and distribution of interactive multimedia titles in various formats, preferably formats to be recorded onto a DVD. The titles can be created and recorded or “burned” locally, or may alternatively be burned at a different location that where it was created such as a retail store or a user's home. A user having a computer or other smart device can have a copy of a title she selects burned at her house without having to create or even know how to create a DVD. The DVD can even contain the user's own selected content.

In one embodiment of the present invention, content is captured at multiple locations and stored locally at a local device. It is also captured at a central location for the purpose of creating chapters and navigation menus. The chapter points and navigation menus are coded into scripts and transferred to the local device. Using a remote program and command line scripts, DVD titles created at the local device can also be stored on a local server.

Various interfaces are provided for creating menus, editing audio and video input, building previews and the final title, and for pre-mastering the final title. In a distributed environment these may be performed at any location. A final end-user need not access or utilize these interfaces, but may simply request a title and optionally provide some content of their own. The editing work will be performed at a location distant from the end-user.

One aspect of the invention is a method of organizing and creating a DVD or other rapid access storage media. The method comprises determining chapter points that define chapters. Menus that access the chapters, as defined by the chapter points, are also created at the first location. Information regarding the chapter points and menus created at the first location is then coded into one or more scripts, and the scripts are then transmitted to a second location. The chapters and menus at a second location are then automatically created with the scripts, and the DVD or other media is then recorded at the second location.

Another aspect of the invention is a method for organizing and storing content. The method comprises receiving various content and creating chapter information by dividing a first copy of the content at a first location, as well as creating menu information at the first location. The chapter and menu information is then transmitted to a second location distant from the first location. At the second location, chapters are created by dividing a second copy of the content at the second location based upon the transmitted information. An output file is then made from the menus and from the second copy, and the file is then recorded to a DVD or other media at the second location.

### BRIEF DESCRIPTION OF THE FIGURES

For a complete understanding of the present invention and for further features and advantages, reference is now made to the following description taken in conjunction with the accompanying drawings.

FIG. 1A is a block diagram showing system 103, an embodiment of the present invention.

FIG. 1B is a block diagram showing system 105, another embodiment of the present invention.

FIG. 1C is a block diagram showing multiple local authoring and distribution centers.

FIG. 1D is an expanded block diagram of local authoring and distribution center 142C of FIG. 1C.

FIG. 2A is a flowchart illustrating the creation of a multimedia title using an embodiment of the present invention.

FIG. 2B is a flowchart illustrating the creation of a multimedia title using a distributed system.

FIGS. 3A-3L are interface screens of the editing subsystem.

FIGS. 4A-4Q are interface screens of the menu creation subsystem.

FIGS. 5A-5C are interface screens of the build subsystem.

FIGS. 6A-6C are interface screens of the pre-master subsystem.

### DETAILED DESCRIPTION

The preferred embodiments of the present invention and their advantages are best understood by referring to the drawings, which will now be described in detail. Like numerals are used for the like and corresponding parts of various drawings.

The present invention is embodied by systems and methods for creating interactive media, such as is currently and most widely available on DVD. Although DVD is the most popular, and thus the preferred multi-media format at the moment, and the creation of DVDs is discussed, it should be understood that the present invention encompasses creation of content on any type of media such as tape, solid state memory, compact discs, and hard disks.

Generally speaking, according to the present invention, an interactive title can be created that allows a user to quickly access organized chapters of content by selecting from on screen menus. The content used to create the title can come from virtually any source, including broadcast television content. The content may be raw footage, or may have already been edited and polished.

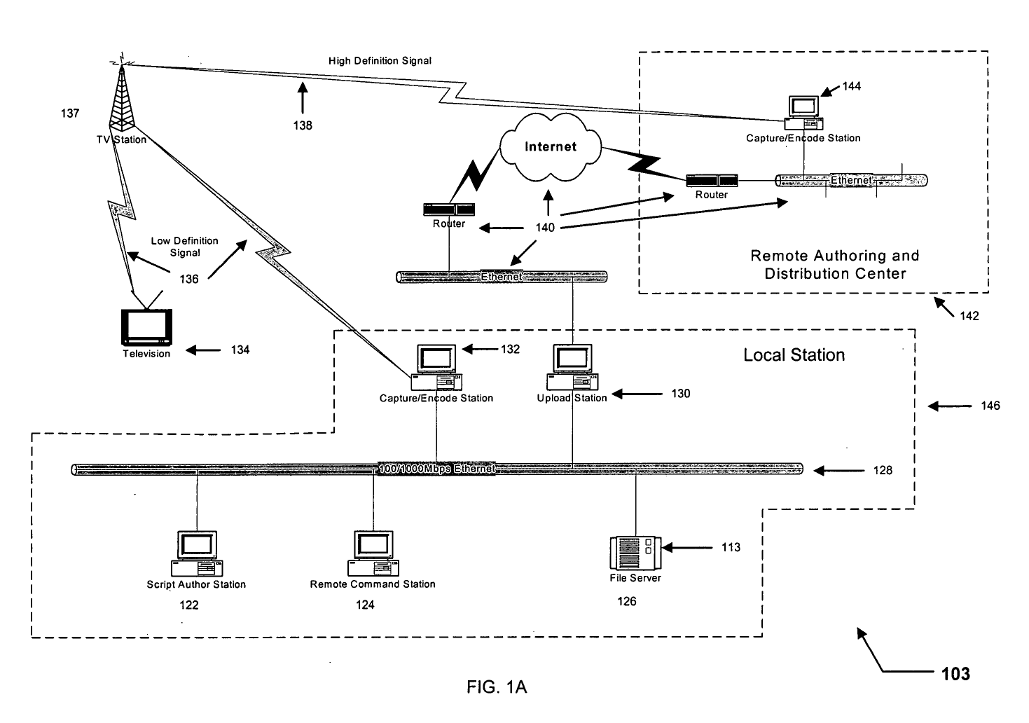

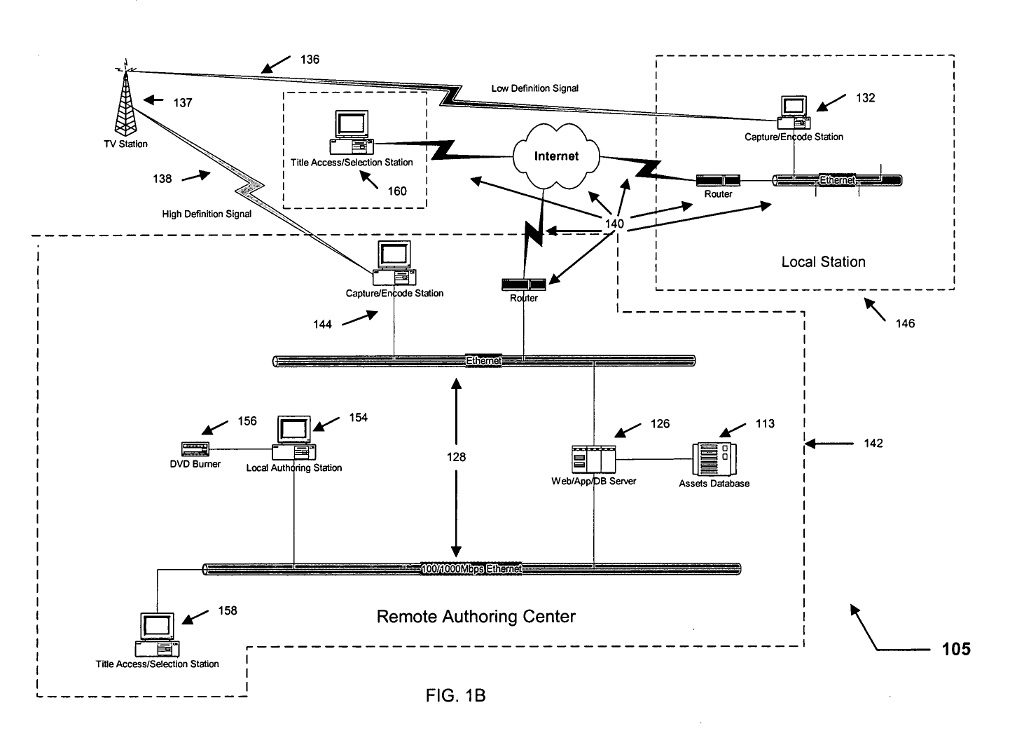

FIG. 1A illustrates system 103, an embodiment of the invention, and a broadcast TV tower 137. System 103 may access content stored on a database located on file server 126, or may optionally capture and store broadcast content, and then use the newly stored broadcast content to create a title or group of content. Generally speaking, there are a number of interconnected workstations connected by a network to a media or content database, although in the simplest of distributed embodiments there are only two workstations/devices connected over a network. The workstations may be any personal computer or RISC processor type workstation. Additionally, one or more of the “workstations” may not be a personal computer but may be a dedicated (set-top or integrated) device.

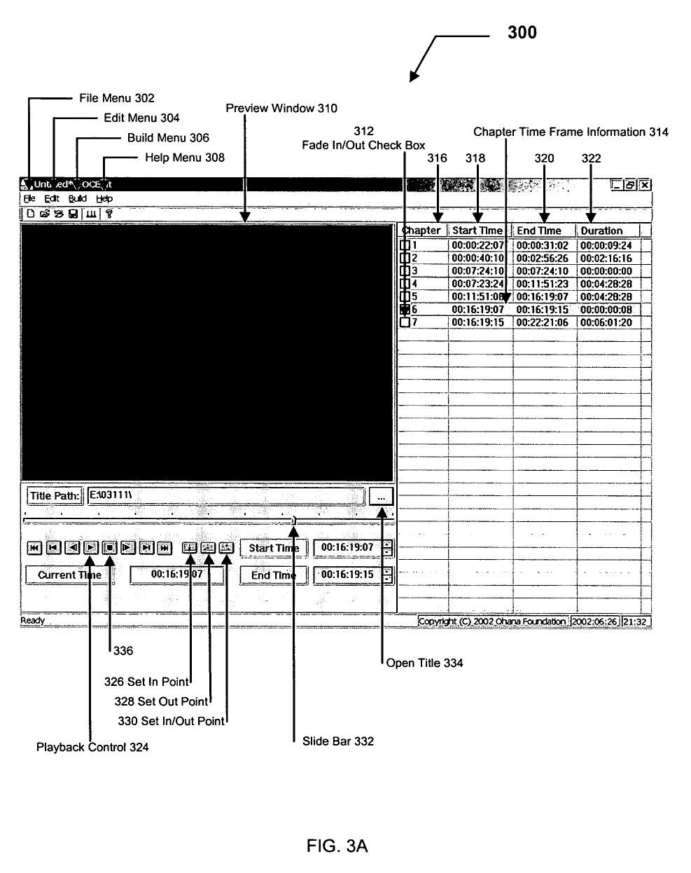

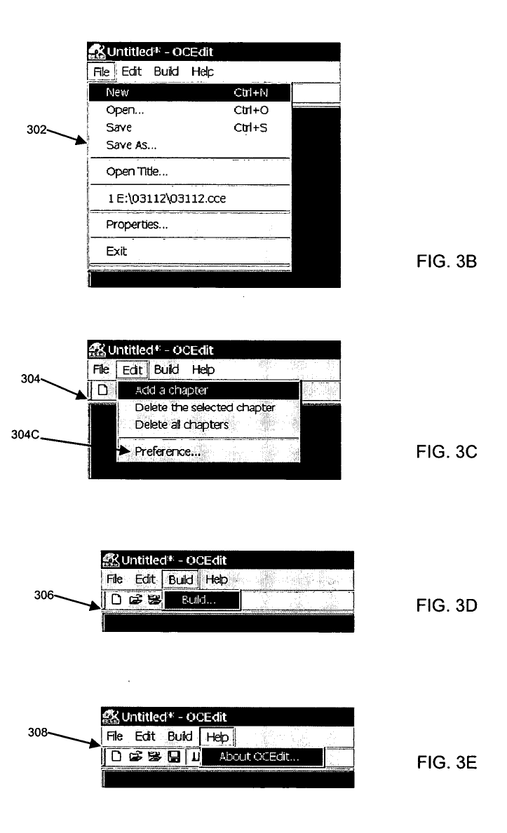

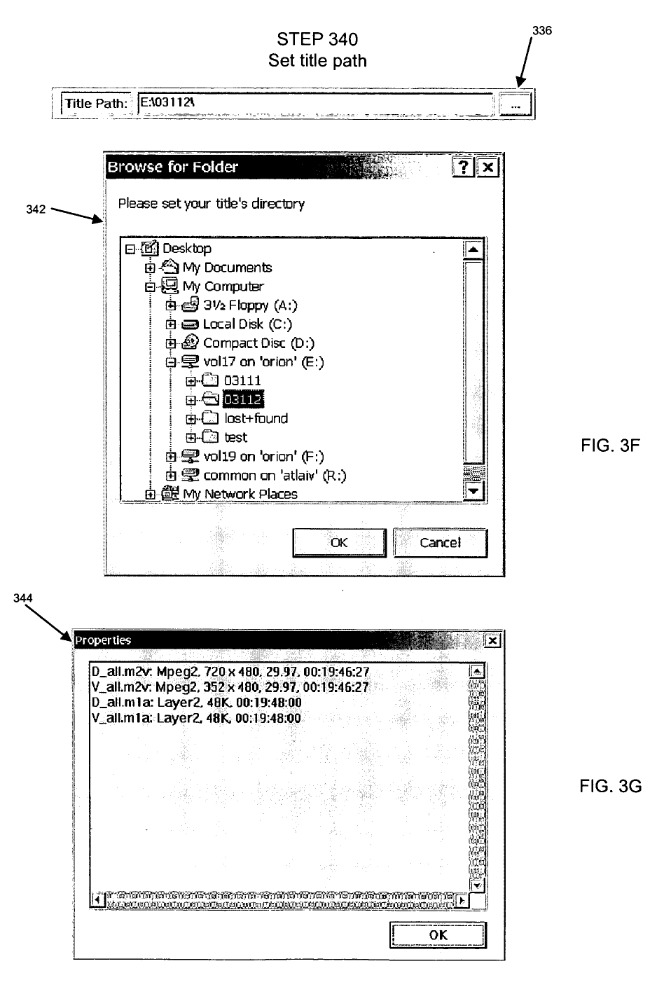

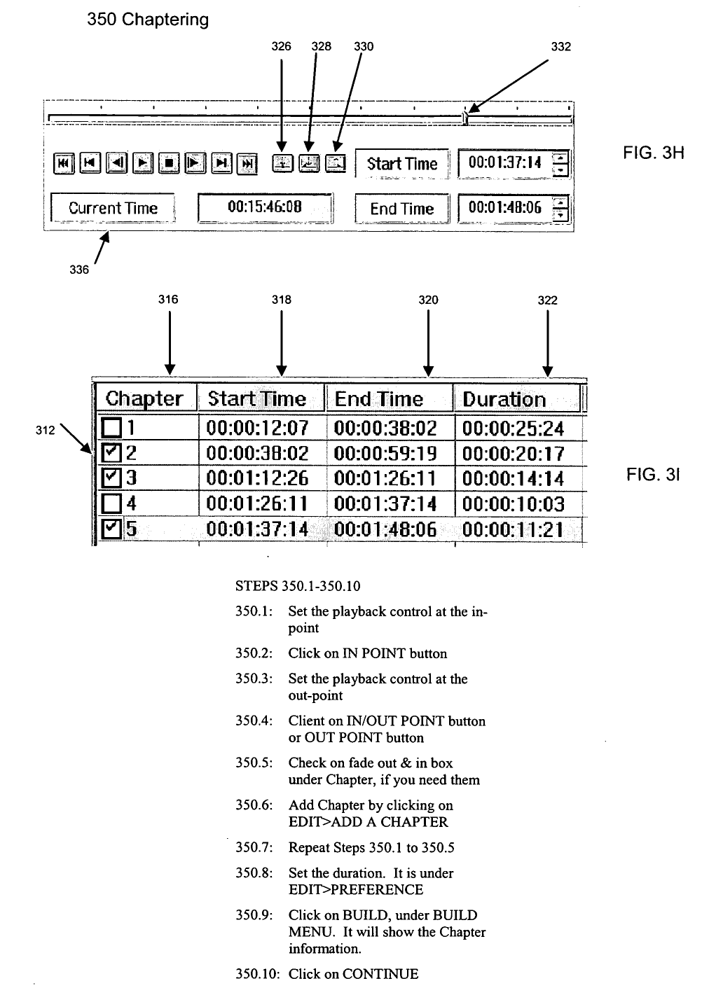

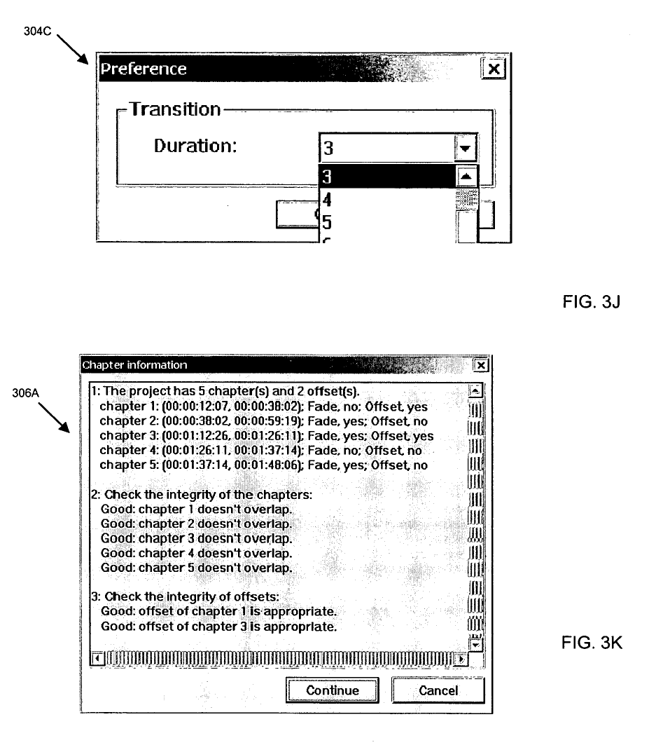

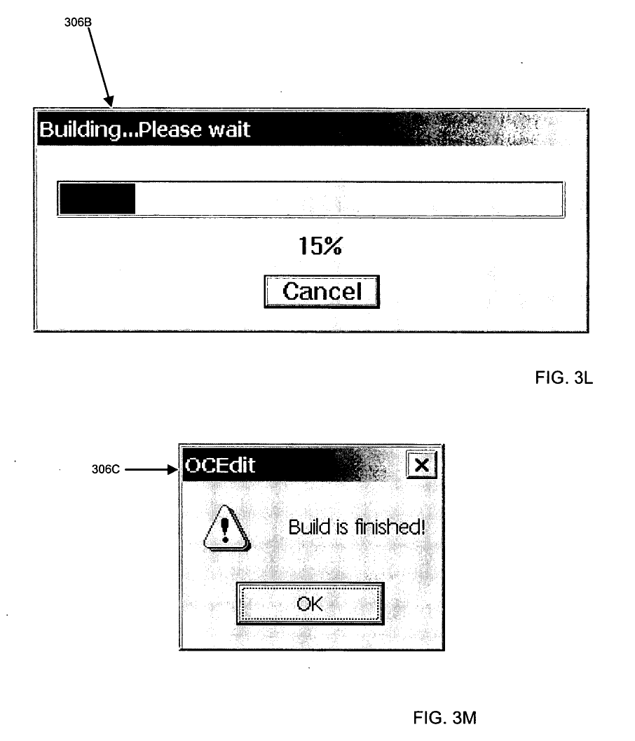

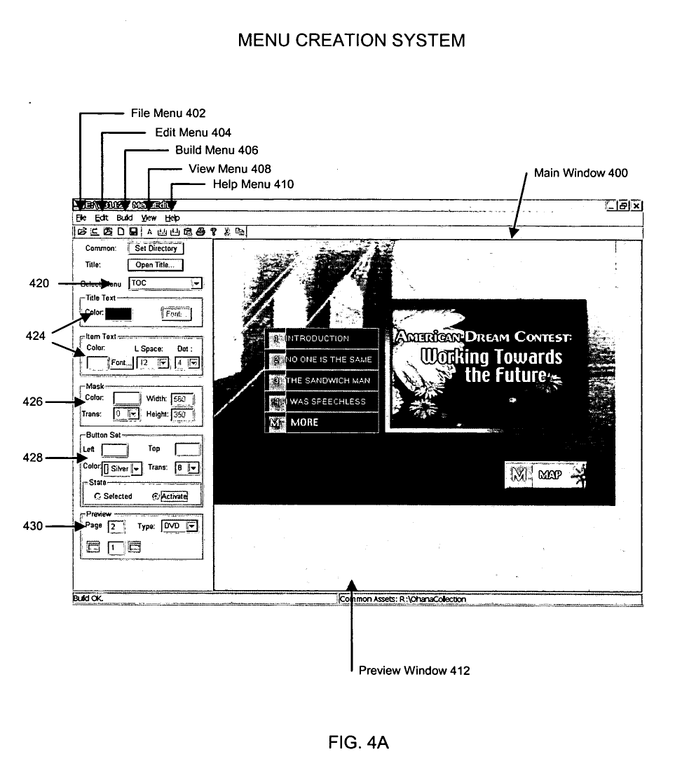

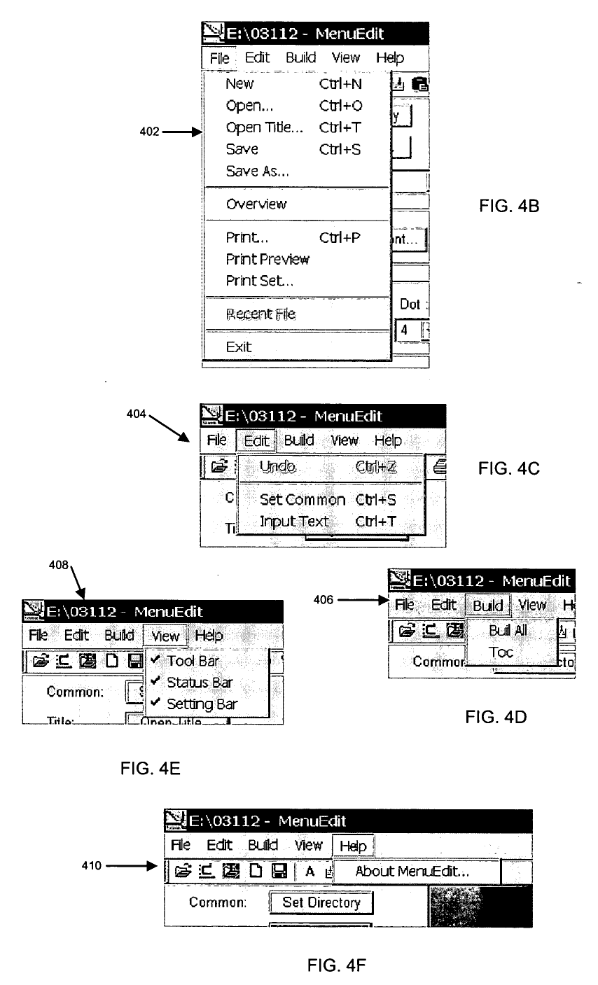

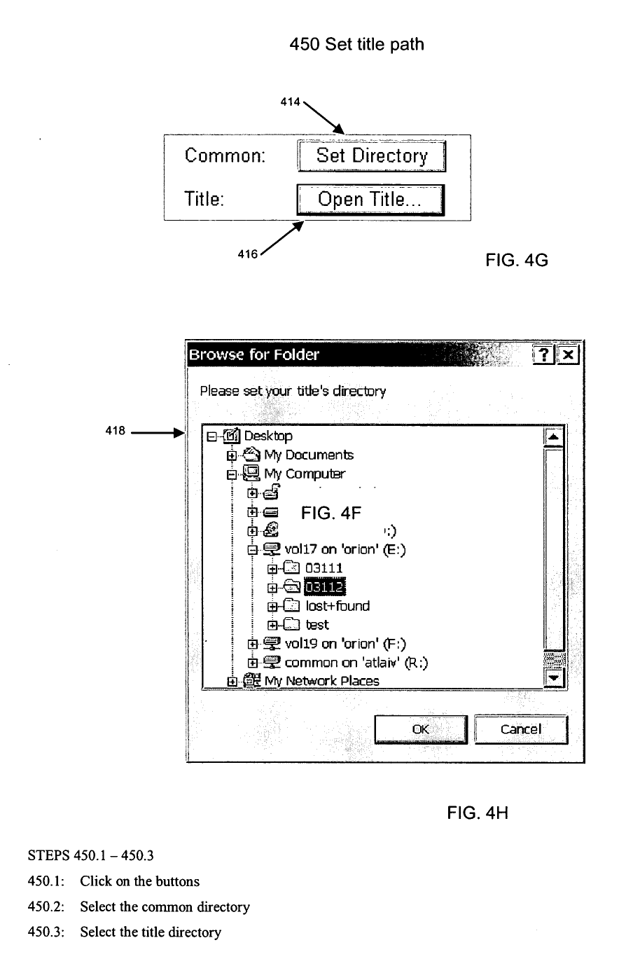

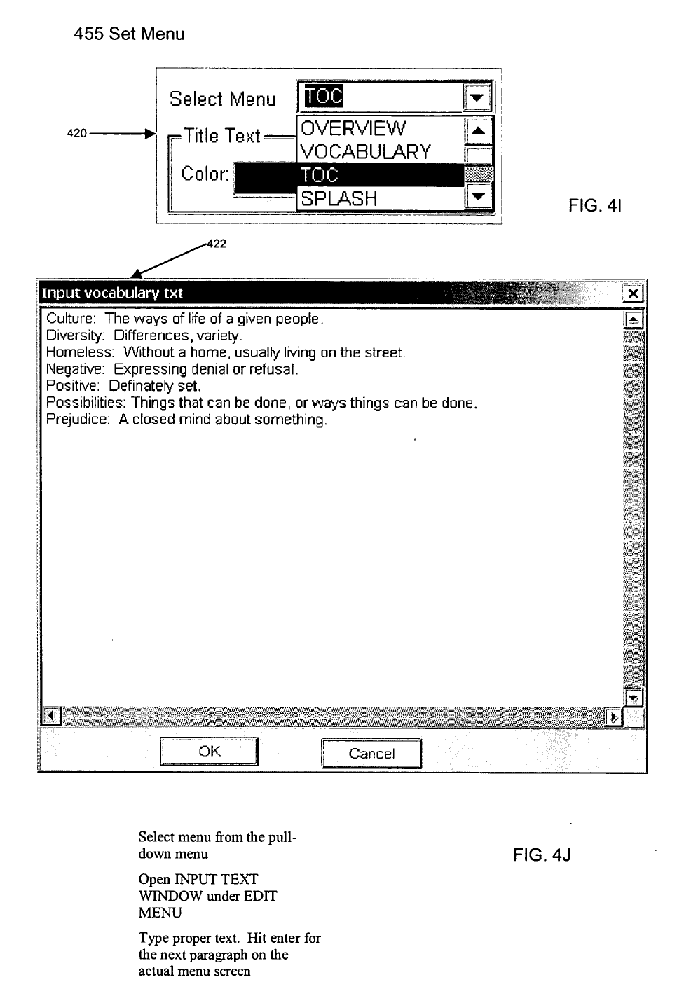

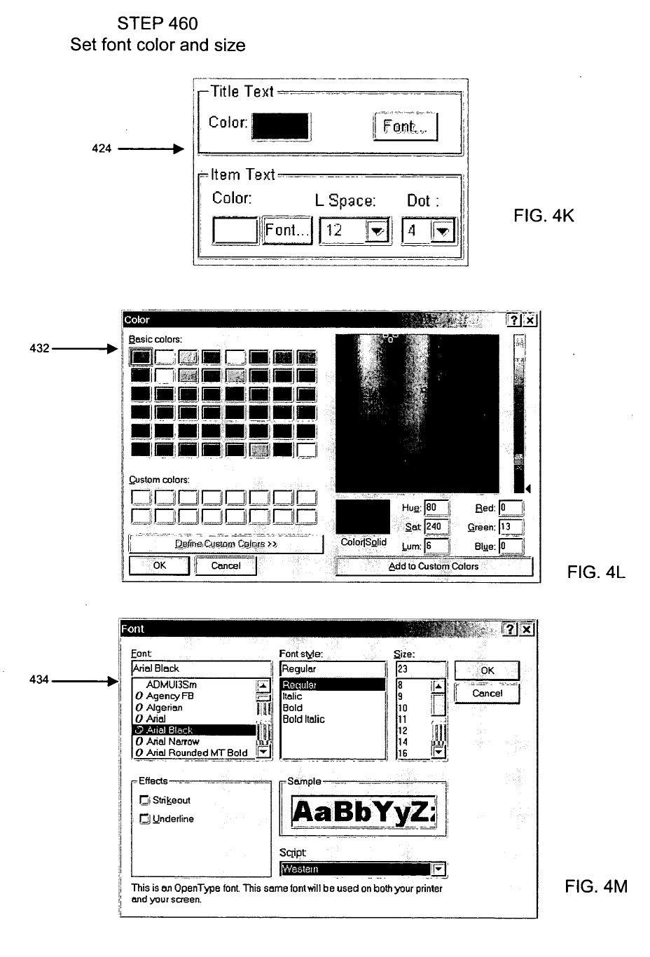

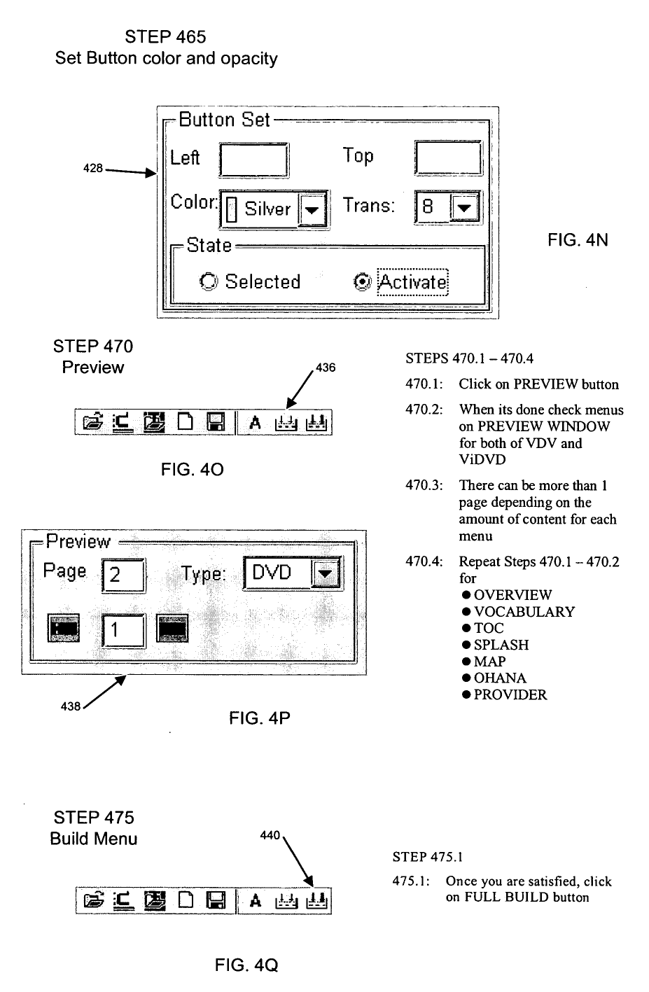

Network 140 may include any type of high speed network such as a local area or wide area network and may also comprise the internet and a connection to the Internet. Therefore the system 103 can be distributed with the components located in different geographic areas. From content database 113 on file server 126, which serves as a repository of content, a media burner, that may be a part of any of the workstations 122, 124, 130, or 132 or may be a stand-alone device, receives the authored title before mastering into a selected format, such as DVD-Video, DVD-Rom, ViDVD or other format. The process of creating a title will be discussed in detail later with regard to FIGS. 3 and 4.

System 103 is optionally equipped to receive a broadcast signal at two geographically distant locations. The same signal that is sent to a typical television 134 is also utilized by system 103. The signal may be broadcast over the airwaves from land based towers or via satellite, or may alternatively be transmitted over wires, such as over a cable or broadband connection. In the embodiment depicted in FIG. 1A, a portion of the content that will eventually end up on the recorded DVD is broadcast from a TV station, as represented by tower 137. The signal may be either a high or low definition signal. As shown, a high definition signal 138 is received by the local authoring and distribution center 142. This content contained in the signal is captured by the remote capture/encode station 144. Capture encode station 144 may be a personal computer or may be a dedicated (set-top or integrated) type device. As a dedicated device, capture/encode station 144 would preferably use a television to display information for configuring the device, as well as the finished DVD, although any display device may be utilized and/or incorporated by the device. The capture/encode station also comprises a DVD recorder capable of recording any of the commercially available DVD standards such as DVD−r DVD+r or whatever standard may be available at the time. The file types may be DVD-Video, DVD-Rom, or ViDVD. Capture/encode (“CE”) station 144 as well as all the stations 122, 124, 130 and 132, may also comprise other storage such as a hard disk drive, CD ROM drive, and flash memory, and may also record the title on those storage devices.

Local authoring and distribution center (“LADC”) 142 is linked to central authoring center (“CAC”) 146 via connection 140 which includes various routers and ethernet local area networks communicating via the Internet. The central authoring center 146 is geographically distant from the capture/encode station 144. CAC 146 may be centrally located, and there may be more than one capture/encode station. Additionally, the system may have a hub and spoke relationship, or the relationship may be a peer-to-peer network where content authored in one location can be assembled and/or recorded in another location. CAC 146 comprises a capture/encode station, an upload station 130, a script author station 122, a remote command station 124, file server 126 including media database 113, and network 128. There may be numerous stations as shown for maximum productivity, or the all of the functionality may be allocated to one station for maximum economy. In the case where numerous stations are present, many tasks can be completed in parallel by multiple users, greatly reducing the time necessary to complete a title in comparison to prior systems that required that tasks be completed serially. The various tasks that may be completed in parallel will be discussed later in reference to the interface screens of FIGS. 3 and 4.

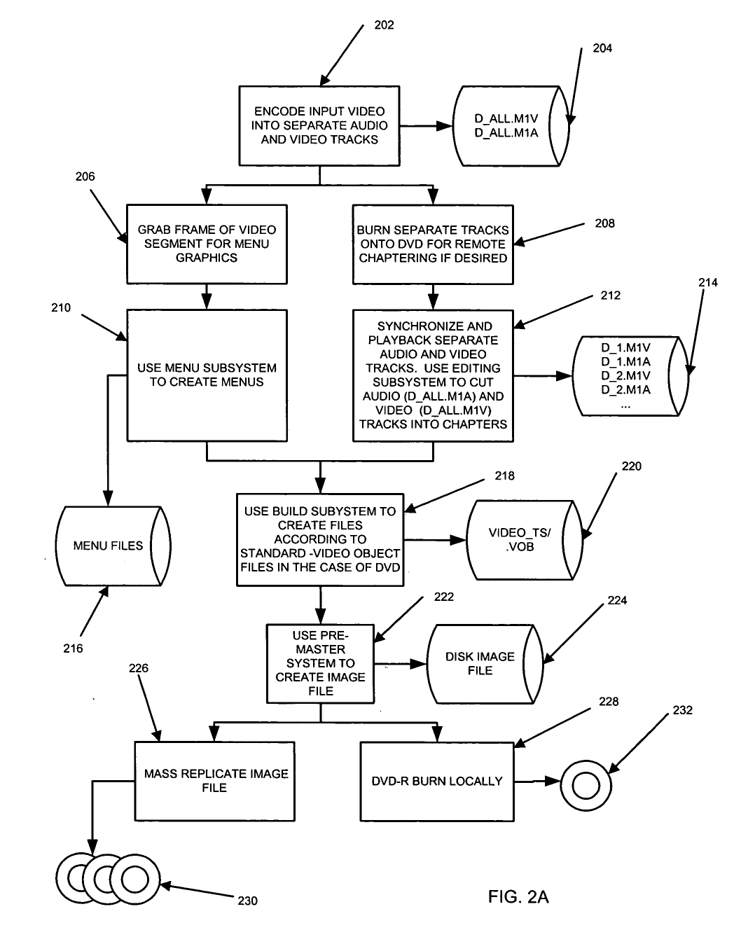

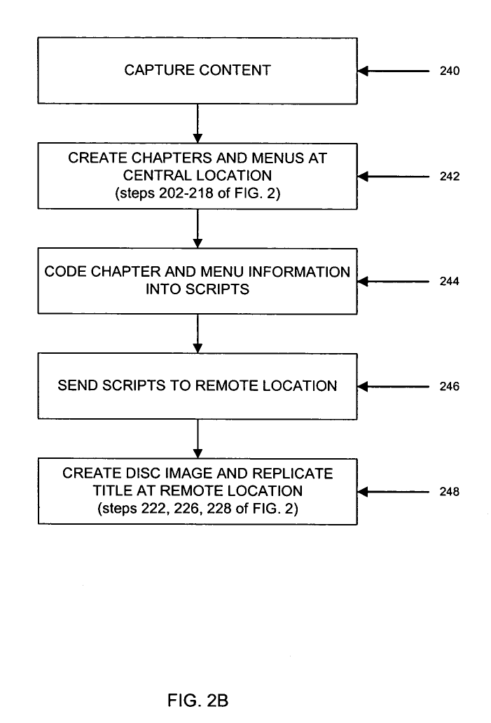

FIG. 1B illustrates system 105, which is similar to system 103. In this system, a variation of a LADC 142 is shown in more detail, whereas a simplified version of CAC 146 is illustrated. An additional remote access and selection station 160 is shown in system 105. This station 160 is an ordinary personal computer, or other smart device, with access to the internet. A user who does not have access to a remote authoring center may select a title to be picked up at the remote authoring center 142 or saved to any of the storage devices of system 105, by communicating with either LADC 142 and/or CAC 146. A list of available titles can be viewed and selected on a web site or other user interface. A database of available titles, and the assets or segments that can be assembled to form the titles, can be maintained at any location such as the CAC 146 or LADC 142. The title may be entirely created at the remote center, or may be created at both the CAC 146 and LADC 142 through a distributed process which will be discussed with regard to FIGS. 2A and 2B.

LADC 142 comprises capture/encode station 144 as previously described, authoring station 154 with media burner 156, database server 126 including media database 113, access and selection station 158 where a user can browse a catalog of previously authored titles stored on a local device, and ready to be burned on a DVD. This station 158 may be useful, if, for example, LADC and station 158 are located in a retail store. Local area network 128 connects all the components. In system 105, a complete title can be created and burned at LADC 142, however, it is preferable to do the editing work at LADC 142 and later have the title burned by a media burner (not shown) of CAC 146. In this fashion, content present at CAC 146 can be turned into a finished title through editing done at LADC 142. This is done by manipulating a copy of the content at LADC 142 in order to determine the chapter and menu information. This information, rather than the finished product, is transmitted to CAC 146 in order to create the finished product at a user location. This avoids having to transmit large content files or the even larger finished DVD. Also, it avoids having to play and record content that is remotely stored, which can be a very slow and tedious process.

For example, in the educational context a student who wishes to learn about a certain topic, physics for example, may select such a title from remote access and selection station 160, or from CAC 146, if convenient. The student can select from a number of complete titles in a library, or may select different modules and assemble her own complete title. For example, the student may choose sub topics in physics such as electricity or projectile motion etc . . . and the system will assemble them all into one title, with quick access to each of the modules. The content that will eventually make up the title will be present at both CAC 146 and LADC 142. If the title has already been completed, the menus and the start and stop points for all the chapters (divisions of the content) will have already been determined. This information can be transmitted in scripts to CAC 146 over network 140. CAC 146 can then utilize the scripts to build a title, and then burn the title onto a convenient media, such as a DVD. The student can then pick up the DVD. Ideally, the CAC 146 in this scenario is conveniently located at the student's school. If it is not convenient, the finished DVD can be transmitted to the student, either by mail, or some other method. If broadband achieves a satisfactory throughput, it is also envisioned the finished title can be electronically transmitted. The distributed system has at least two principle advantages. It avoids having to transmit the very large finished titles electronically (although it is still possible). It also allows users who either do not have the expertise or the access to create a DVD to do so.

FIG. 1C illustrates another embodiment of a distributed system. Central authoring center 146 is linked via network 140 to various local authoring and distribution centers located throughout the world. For example, LADC 142A can be located in Hawaii, LADC 142B can be located in Japan, and LADC 142C can be located in Korea, and so on. These centers can be located in stores or schools or virtually any environment where it would be desirable to replicated a finished media. FIG. 1D shows that any of the LADCs can actually comprise or be linked to multiple LADCs. In other words, there can be multiple authoring and distribution stations in any one location, such as for example Korea; LADC 142 comprises LADC 142C₁, 142C₂, and 142C₃.

FIG. 2A illustrates a method of creating a DVD or other media format according to an embodiment of the invention. In step 202 an input video, which may or may not include accompanying audio, and is typically a video tape or other video file, is encoded into separate audio and video tracks or segments. The tracks or segments are typically relatively long so that they may later be subdivided. The separate audio and video tracks are saved onto the storage devices of the system 100 in step 204. The video track illustrated is D_ALL.M1V, and the audio track is D_ALL.M1A. Generally one audio and video track are created and saved onto the storage device. However, in some cases where the necessary information is not contained in one input file or tape, multiple inputs may be used and will result in multiple outputs (audio and video tracks).

Most multimedia players today require that the video track and audio track be multiplexed, or “muxed”, together to form a sequence of packets, each packet containing a small segment of video and one or more accompanying audio packets. This is so that when these packets are laid out on an optical disc in a contiguous manner, minimum read-head movement is needed during playback therefore eliminating potential seek delays. Since the output from a typical encoder yields separate video streams and audio streams, it is a time consuming and difficult step when creating a title to have to mux them together for playback purposes during authoring and then de-mux them for cutting/editing. Because the systems embodying the present invention save the audio and video tracks, chapters and the disc image to a magnetic disk, where head movement efficiency and throughput are much higher than those of optical discs it is not a problem to synchronize and playback the separate audio and video tapes. The systems of the present invention take advantage of this and preprocesses the video to derive precise timecodes, at about ½ sec intervals. These precise timecodes are used to synchronize the video track with the audio track during playback within an editing session. Therefore, the separate tracks do not have to be multiplexed for playback and editing.

To accomplish this, the system utilizes a MPEG-2 decoder that can play separate audio and video tracks simultaneously, unlike most commercially available decoders that are designed to play already muxed “system streams” or audio and video tracks, or alternatively to play video and audio streams separately.

If for some reason, a person (“user” or “author”) who wishes to create a DVD cannot access system 103 or 105 either directly or remotely via high speed network 112, the author can work independently. The remote user may use an embodiment of the invention comprising a single computer. The remote author's contribution can later be integrated with that of other authors to form a finished title, if so desired. In order to work remotely, the audio and video tracks may be burned onto a DVD or other media for remote chaptering in step 208.

The creation of the chapters and the menus may take place in parallel in order to minimize the time necessary to create a finished title, whether it be on DVD or other format. They may also, of course, take place serially. In step 212, the system will synchronize and playback the separate tracks saved in step 204 so that an author or other user may watch the tracks and decide how he would like to subdivide the information into chapters. The author uses the editing subsystem, described later in regards to FIG. 3, to cut the audio and video tracks into chapters. This is accomplished by stopping or pausing the playback and clicking on buttons to input the chapter start and finish times and will be described later in further detail. The separate chapter video files and audio files for each chapter are saved in step 214. In this example, the files for two chapters are illustrated: chapter 1—D_{—}1.M1V and D_{—}1M1A; chapter 2—D_{—}2.M1V and D_{—}2.M1A.

In a distributed system, such as that shown in FIGS. 1A and 1B, the steps may be distributed between two or more authoring centers or systems.

The chapters may also include subtitles or other textual information. For example, subtitles may include translations of foreign languages. Multiple language subtitles may be saved with the chapters so that the user may simply select the language of choice.

The author can also select effects, such as gradual fading in and out of picture and sound at the beginning and ending of a chapter from one of the settings options provided on the editing system 300 for that purpose. These effects will determine the replay features of the video for the chapter. At this stage the precise links that each chapter will make to a variety of other resources, such as Web based resources or other local text or image files that will provide additional reference material for the chapter, are made via the editing subsystem. Access between the web and DVD media via these links will be discussed later in reference to FIG. 7. The additional reference material may include any text that may add to the audio, such as subtitles, or translations of spoken words. There is no prescribed limitation on the number of chapters, their order, the number of linked files or whether they will ultimately reside on the DVD disk or will be called from the Web. It is immaterial, as the Editor subsystem may create buttons that access a wide variety of files, links, or addresses.

Steps 206, 210 and 216 illustrate the creation of the menus using the menu creation subsystem. In step 206, the user grabs a frame of the video track for use as a menu background. This is simply done by stopping or pausing playback of the video track and clicking on a button of the menu subsystem to select the desired menu background. Creation of the menus also involves creating the various buttons and text that a viewer uses to directly access the chapters of the title, and will be described in further detail later with regard to FIG. 4. The buttons are graphic areas that when clicked upon instigate a series of actions that access chapters. A user need simply instruct the system to create the button, and the system will automatically create the underlying functionality of the button that links directly to the assigned chapter, or other content. In step 210, based upon the user's selection, the menu subsystem creates the menus for the title, and in step 216 the menu files are saved.

Once the menus and the chapters are created, the user then accesses the build subsystem to create files according to accepted industry standards and/or proprietary formats in step 218. In the case of a DVD, video object (VOB) standard files are created. In step 220 the video object files are saved to disk. In this illustration VOB file VIDEO_TS/.VOB is saved to disk.

Next a disc image file must be created for subsequent mastering of the disc. In step 222, the disc image file is created using the pre-master subsystem. In step 224, the disc image file is saved.

The user may then decide whether he desires to have the disc image mass replicated and/or make a few copies locally with a DVD burner. In step 226, this image file is transmitted to a replication facility to create finished DVDs 230. This is not done with system 100 but is done with a dedicated mass replication system. On the other hand, the user may use system 100 to burn a DVDR 232 in step 228.

FIG. 2B illustrates an embodiment of distributed development. In step 240, the content is captured. This can happen in any number of ways. The content can be transferred from an existing source such as videotape or any analog or digital medium. It can also be captured in real time from any broadcast source. In this process, the content is typically duplicated such that a copy is sent from one location to another location. This can be done so that the copy is available simultaneously at all locations, or alternatively, it can be sent from a first location to a second location after processing is completed at the first location. In step 242, chapters are created from the content, i.e. the content is divided into discrete segments, and menus are made to quickly and easily access the chapters. This is done at a central authoring center 146 seen in FIG. 1B. For more details refer to steps 202-218 of FIG. 2A.

In step 244, a script including the chapter and menu information is created in step 242. Step 244 may happen at the same time or slightly after step 242. The script contains information regarding the beginning points of the chapters, and menu information such as the number and location of buttons on the screen and the functionality of the buttons. Alternatively, the entire menu files may also be transmitted, although this is more cumbersome to transmit the entire menu files. These scripts or other information are then sent to a another location, such as local authoring and distribution center 142 of FIG. 1B, in step 246. The format of these scripts can be seen in files on the accompanying CD, which are hereby incorporated by reference in their entireties. Sample “scripts” for menu building are available in config.ini. A directory listing of the menu source files which will be sent from the central location to the remote location for building is present in dir.txt. Chaptering commands are in the .oce file (02074.oce) which is a binary file, and OMTwrite.cfg is the script file for writing the DVD disc image to be used for burning the disc.

In step 247, subtitles in a local language may be added at the local location, if it was not already done earlier in the process. This can be done at many locations and conveniently enables multiple and even obscure languages or dialects to be subtitled by local speakers. An audio track in a local language can also be added at the local location. In step 248, the local authoring and distribution center utilizes the scripts to create a disc image and create one or more copies of a complete DVD title using locally available content. This can be seen in more detail in steps 222, 226, and 228 of FIG. 2A. In this fashion, a user at a location far from the central creation station can create a DVD on demand from content that is locally available, for example on a hard drive or other memory of the local authoring station. Using scripts provided by the central station, the user can create a DVD with various menus and readily access content of his choice. One application for such a process is a recorder that can record TV or other programming onto a DVD based on instructions from a central station. For example, a DVD, including menus, can be created from a broadcast TV program. Additionally, any other available content can be included in the DVD. For example, the DVD could contain a mix of programming a user filmed himself, such as home movies, together with professionally edited content. Thus, a very flexible tool has been created that, in simple terms, takes the hard part out of creating a DVD. A user need not know how to create, or invest the time to create, the chapters and menus of a DVD.

he user interface screens of the various interfaces and subsystems according to one embodiment of the present invention will now be described in detail. It should be understood that these screens are provided to illustrate one way of practicing the invention, and that many ways are possible, as defined by the appended claims. These interface screens may not be present in a dedicated local device as much of the input would take place remotely. In general, only certain users of the distributed systems would need to edit the content, and thus only certain users would access such interfaces.

The system of the present invention may be considered to have a number of subsystems that each perform different types of tasks. Some of the subsystems may be used concurrently in parallel to arrive at a finished production quality DVD or other type media. The pull down menus, and the interfaces that will be described have the familiar look, feel, and structure of the well known Microsoft Windows® interface. The functions in the pull down menus may duplicate the direct access buttons available on the various interface screens and may introduce additional less often used functions, features, and information.

FIG. 3A illustrates the main interface 300 of the editing subsystem. The interface 300 has several pull down menus in the upper left hand area of the screen: file menu 302; edit menu 304; build menu 306; and help menu 308. Clicking on each of these menus reveals a number of functions relevant to each of the menus. Preview window 310 displays video files for playback and editing. Editing details are shown on the right of the interface. This information reflects what is being generated by the controls in the bottom left of the interface.

Playback controls 336 include buttons for starting playback, forward and reverse cueing at different rates, forward and reverse segment advance, pause, and stop. Set in point button 326 is used to mark the time where a chapter will begin. Set out point button 328 is used to mark the time where a chapter will end. Set in/out point button 330 can be used to set either the in or out point depending on whether an in point or out point has already been set for a particular segment. Slide bar 332 shows the position within a chapter or clip that is presently being displayed in preview window 310. Slide bar 332 may also be moved by the user in order to skip to a different time within the clip being viewed. When activated, open title button 334 will allow the user to open a title for editing with interface 300. Chapter column 316 displays the number of chapters the user has designed. Each chapter displayed within chapter column 316 also has a fade in/out check box 312 that a user may check if the user would like a particular chapter to fade in and out. Chapter time frame information is displayed in start time column 318 and end time column 320. The Duration of the various chapters is also displayed in duration column 322.

FIGS. 3B-3F illustrate the pull down menus 302-308 seen in FIG. 3A, after a user has selected or “pulled down” each of the menus. FIG. 3B illustrates file menu 302. In file menu 302, the typical file features for opening new and current files and saving files are present.

FIG. 3C illustrates edit menu 304, where chapters can be added and deleted, and preferences set. FIG. 3D illustrates build menu 306, where the build operation may be selected. The build operation, and the other operations and functions will be discussed later, in an example of creating a finished product. FIG. 3E illustrates the help menu, where information about the system and other help functions may be found.

FIGS. 3F-3M will be used to give a general operating overview of the system, and in particular of the editing subsystem. In step 340, the title path for the input file or files is set by the user. This is done by activating title path button 336. The user can then select the file or files with browse menu 342. The properties of the selected file may also be displayed in properties window 344, shown in FIG. 3G, by selecting properties in file menu 302. After the input file or files have been selected, chapters may be made from the file(s). For each of the chapters, the user marks the in-point by setting playback control at the in-point in step 350.1. This is done with using the playback controls 336 seen in FIGS. 3A and 3H. In step 350.2, the users sets the in-point by clicking on the in-point button 326 or in/out point button 330. The user then sets the playback control at the out-point using the playback controls 336 in step 350.3. In step 350.4, the user sets the out-point by clicking on the out-point button 326 or in/out point button 330. Then, the user may select whether or not a chapter should fade in or out by checking the fade box 312. The chapters and fade boxes 312 are shown in FIG. 3I. If the fading is desired, the duration of the fade time can be set in preference window 304C selected through edit menu 304, as seen in FIG. 3J. This is then repeated for as many chapters as the user would like to create. The user can view all the chapter information at any time by selecting build from build menu 306 and the window will be displayed in chapter information window 306A as seen in FIG. 3K.

If the chapter information is satisfactory, the user can build the individual chapter files. Each chapter will then have its own audio and video file which can later be accessed through the menu structures. The chapter files are built by selecting the build command seen in build menu 306, shown in FIG. 3D. The building process is shown in windows 306B and 306C of FIGS. 3L and 3M, respectively.

The menu creation subsystem is illustrated in FIGS. 4A-4F. The main menu creation window 400 is shown in FIG. 4A. It is comprises preview window 412, and numerous other buttons and pull down menus, some of which will be described further in subsequent figures. The pull-down menus include: file menu 402; edit menu 404; build menu 406; view menu 408, and help menu 410. There are also short-cut buttons just below the pull down menus that replicate some or all of the pull down menu functions. Menu creation window 400 also includes set directory button 414, open title button 416, item text window 420, mask window 426, button set window 428, and preview window 430.

File menu 402 is shown in further detail in FIG. 4B, where general file functions for opening and saving and printing are available. Edit menu 404 is shown in FIG. 4C, where text may be input from another application, and SET Common sets the directory path where common assets are located. Common assets are graphic elements and video/audio clips that are used by all titles to retain a consistent look and feel. FIG. 4D shows build menu 406, where the build all option and the build table of contents (TOC) option is available. FIG. 4E shows the view menu 408 and its available options, and FIG. 4F shows the help menu 410.

Operation of the menu subsystem will be illustrated with regard to FIGS. 4G-4Q. In step 450, the title path is set. This is done with the set directory button 414, the open title button 416, and the browse window 418 shown in FIGS. 4G and 4H. In step 455, the menu text is set using pull down select menu 420, as shown in FIG. 4I. With select menu 420, the user can select which menu to create or edit. Text is entered in text input window 422, as seen in FIG. 4J. In step 460, the font color and size is adjusted with text windows 424, 432, and 434 as seen in FIGS. 4K, 4L, and 4M, respectively.

In step 465, the button color and opacity may be set using button set window 428 shown in FIG. 4N. In step 470, the user may choose to preview the menus before build step 475. This is accomplished by pressing the preview button 436. When preview window 438 seen in FIG. 4P is visible, the preview page and type may be selected. There can be more than one page depending on the amount of content for each menu. More than one type of output may also be chosen. The types may be: DVD-Video, DVD-Rom, ViDVD, or other video formats. Steps 450-470 are then repeated for each menu screen desired. The user may select however many menus they wish. In step 475, after the user is satisfied with the preview, he or she can build the menus and the various menu output files using build shortcut button 440 seen in FIG. 4Q, or may do so through the build pull down menu 406.

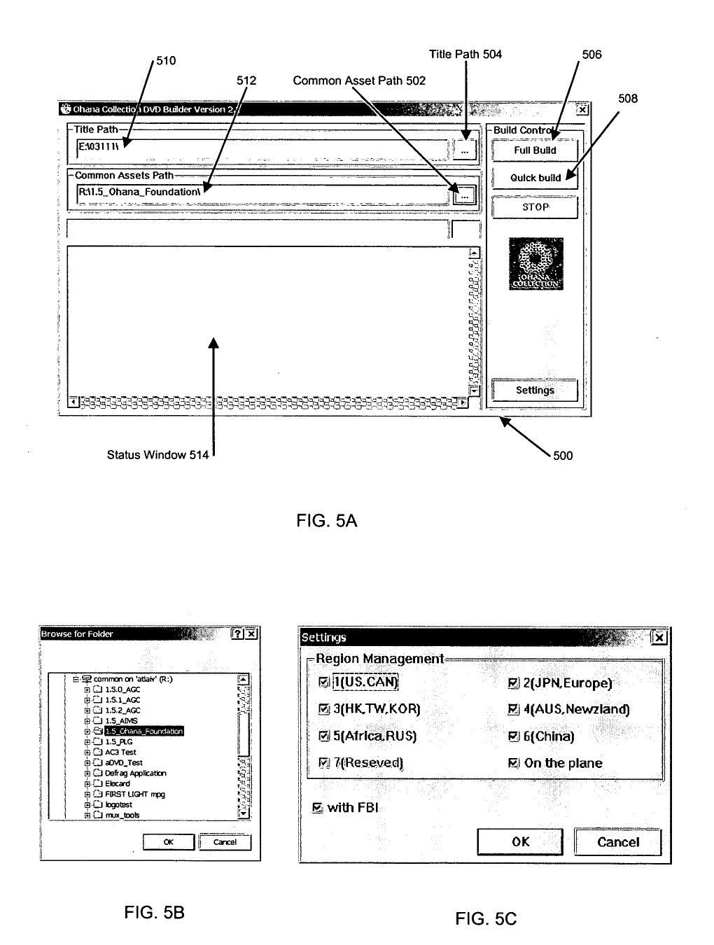

FIGS. 5A-5C illustrate the build subsystem. Some aspects of the build subsystem have been described with regard to build shortcuts in the previous subsystems. Main interface window 500 generally controls the build process, but the build process may be invoked from within the other subsystems. In box 510 and box 512 the title path and common assets path are respectively set. The user can, browse for title path or common assets path by selecting the common asset path button 502 or title path button 504, respectively. Once these have been set, the user can also check and set the settings for various DVD region codes according to the DVD-Video specification and decide whether to include the familiar FBI warning regarding unauthorized duplication. The user can select a Full Build or a Quick Build with buttons 506 and 508, respectively. A Quick Build is an abbreviated version of Full Build, where only the first 30 seconds of each of the chapter video will be used to create a logically correct title with all the menus and buttons correctly linked. This is useful for providing a quick quality assurance check as it can be built usually in 1/10 the time and can be put on a low cost CD-R media. A Full Build includes the entire content of the formal title.

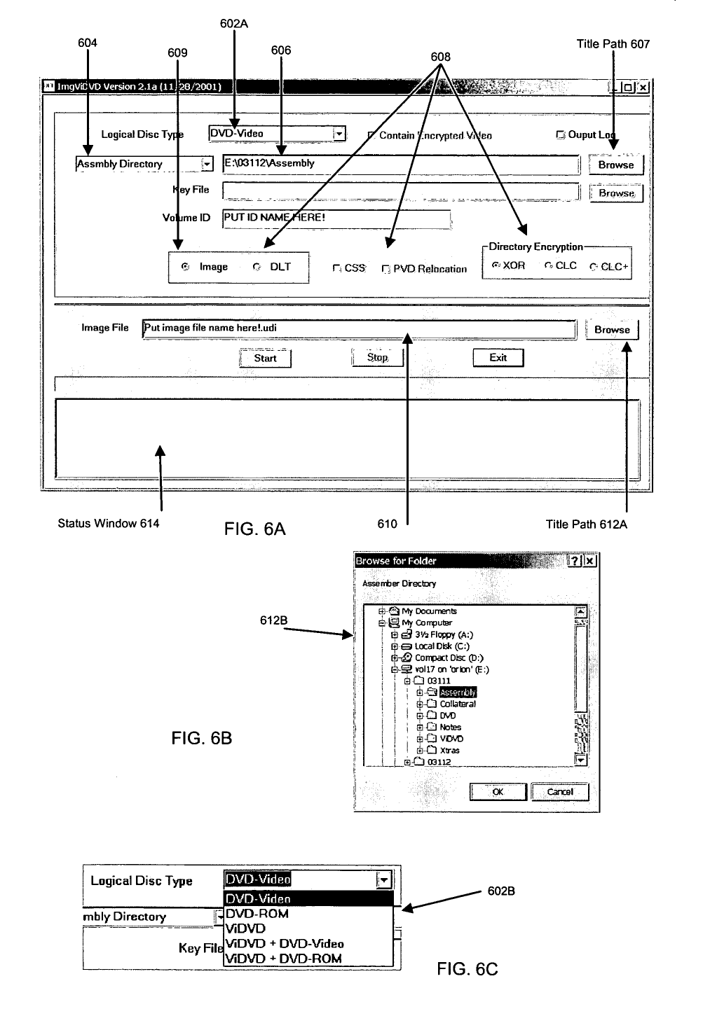

FIGS. 6A-6C illustrate the image or pre-mastering subsystem. Initially, the user selects the assembly directory with box 604, i.e. the user selects where the various assembly files will be saved. In box 602A, the logical disc type can be selected. When the pull down menu of box 602A is selected the choices of box 602B of FIG. 6C become available for selection of a logical disc type. The logical disc type can be DVD-Video, DVD-ROM, ViDVD, and combinations such as ViDVD+DVD-Video and ViDVD+DVD-ROM. The complete title path can be input in box 606, or if the user wishes to browse for the title path with title assembly path button 607, browsing window 612B shown in FIG. 6B will appear. The encryption type can also be selected in box 608, and the output destinations can be set in box 609. If Image is selected, then the disc image is output to a file on the local file system, ready to be written to a DVD−R using DVD burning software. If DLT is selected, then the disc image is output to the locally connected DLT tape drive, ready to be sent to the replication facility for mass replication. This disc image may also be saved to a writable DVD media (dvd−r,dvd−rw, dvd+r, dvd+rw) for before mass replication. Status window 614 indicates the presence of errors and describes the status during the process of producing the final image output. The image file location is shown and can be edited in box 610 and the Browse button 612 can be used to set it by browsing through the file system with windows 612A and 612B.

The present invention has many advantages over prior manual and semi-automatic systems. The present invention circumvents the problems that manual authoring systems sometimes encounter when creating long titles such as feature films, that exceed a certain critical running time (or length).

In some prior systems, the editor could not combine files above a critical size (that relates to the running time) so that the title could be played back continuously, due to the limitations of the underlying hardware and software systems. Therefore, the author had to introduce a series of shorter segments with artificial breaks. In many prior systems this had to be done manually.

With the present invention, the author can include chapters or segments and instruct the system, with “one click”, to run them seamlessly together as one continuous playback. To do this the author uses the interface of the editing subsystem to create a play list of the segments to be joined together logically. If this play list totals segments that exceed the critical size it is of no consequence, as on the “click” of the Play button of the Editor subsystem the play list will be used to play back the segments seamlessly as if they are concatenated together. Therefore, system 100 can create titles from input video segments of any running time regardless of the underlying workstation hardware or type.

The present invention significantly enhances productivity over manual authoring systems and methods that have been developed to date. To minimize the time to produce a title, many people can work on the project at different stations simultaneously, or in order to minimize the capital costs of the system, the entire system may comprise one computer, and the work may be performed on the single computer. The one time coding and the automated “assembly line” process minimize or eliminate waiting time by authors, and reduce the amount of manpower required for a given project. All the tasks may be performed on either one computer, or preferably on more than one computer to maximize the parallel development capability of the system.

Additionally the distributed embodiments make it possible to perform complicated tasks that may require significant expertise and equipment at one location distant from a user, and to encode that information and transmit it to a device at a an end user's location. Thus, a relatively simple system can be produce a title or other quickly accessible content with a limited amount of input from a user.

While embodiments of the present invention have been shown and described, changes and modifications to these illustrative embodiments can be made without departing from the present invention in its broader aspects. Thus, it should be evident that there are other embodiments of this invention which, while not expressly described above, are within the scope of the present invention and therefore that the scope of the invention is not limited merely to the illustrative embodiments presented. Therefore, it will be understood that the appended claims set out the metes and bounds of the invention. However, as words are an imperfect way of describing the scope of the invention, it should also be understood that equivalent structures and methods while not within the express words of the claims are also within the true scope of the invention.

### APPENDIX A

The attached compact disks are in IBM-PC format and are compatible with MS-Windows.

Directory of D:\

APPENDIX A
The attached compact disks are in IBM-PC format and are
compatible with MS-Windows.
Directory of D:\

| Path\Filename | Size | Type | Creation Date |
|---|---|---|---|
| D:\02074.oce | 1KB | OCE File | 3/15/03 |
| D:\config.ini | 3KB | Configuration Settings | 3/15/03 |
| D:\dir.txt | 4KB | Text Document | 3/15/03 |
| D:\OMTwrite.cfg | 1KB | CFG File | 3/15/03 |

1. A method of organizing and creating a title on a rapid access storage media, comprising:
at a first location determining chapter points that define chapters, and creating menus that access chapters defined by the chapter points;
coding information regarding the chapter points and menus created at the first location into one or more scripts;
transmitting the one or more scripts to a second location;
automatically creating the chapters and menus at a second location with the scripts;
recording on the media, at the second location, the title including chapters and menus that access the chapters.

2. The method of claim 1 further comprising capturing broadcast content at both the first and second locations.

3. The method of claim 1 further comprising creating subtitles at the second location.

4. The method of claim 2 wherein a first copy of the content is captured at the first location and a second copy of the content is captured at the second location, and whereby the coding information is generated based upon the first copy and the content of the chapters comprises content of the second copy.

5. The method of claim 4 wherein the first copy is of a lower resolution and size than the second copy.

6. The method of claim 5 wherein the second copy comprises high definition content.

7. The method of claim 1 wherein automatically creating the chapters at the second location comprises:
converting captured content into separate audio and video streams;
indexing the separate audio and video streams;
synchronizing the indexed and separate audio and video streams; and
subdividing the separate and synchronized audio and video streams into separate and synchronized audio and video chapter files.

8. The method of claim 1 wherein the content is captured at one location and transmitted to the other location.

9. The method of claim 8 wherein the content is transmitted electronically.

10. The method of claim 8 wherein the content is saved to a medium at one location and the medium is transported to the other location.

11. The method of claim 1 wherein automatically creating the menus at the second location comprises:
creating one or more button images;
associating the button images with the created chapters such that when the button images are depressed, the chapter will be selected and played in a final title.

12. The method of claim 11 wherein associating the button images comprises automatically correlating the x-y locations of the buttons on the image with respective actions, such that when a user clicks on or selects one of the x-y locations one of the actions is initiated.

13. A distributed DVD creation system comprising:
a first device at a first location that is operable to:
convert content into separate audio and video streams;
index the separate audio and video streams;
synchronize the indexed and separate audio and video streams; and
a second device at a second location, the first and second devices in communication with each other, the first device operable to instruct the second device to:
divide the synchronized audio and video streams into chapters;
record a DVD with menu functions that access the chapters.

14. The system of claim 13 wherein the first device utilizes a first copy of the content, and a the second device utilizes a second copy of the content, the second device operable to divide a second copy of the audio and video streams into chapters.

15. The system of claim 13 wherein the first and second device utilize the same copy of the content, the copy transmitted from the first to second device.

16. The system of claim 13 wherein the second device is at a user location.

17. A method for organizing and storing content comprising:
receiving various content;
creating chapter information by dividing a first copy of the content at a first location;
creating menu information at the first location;
transmitting the chapter and menu information over a network to a second location distant from the first location;
creating chapters by dividing a second copy of the content at the second location based upon the transmitted information;
building an output file from the menus and from the second copy; and
recording the output file to a DVD or other media at the second location.

18. The method of claim 17 wherein creating chapters and chapter information comprises:
dividing the content into audio and video files;
indexing the audio and video files;
synchronizing the audio and video files using the indexed content;
dividing the synchronized audio and video files into chapter files based upon input from a user.

19. The method of claim 17 wherein the menu information comprises a number of buttons and location of the buttons.

20. The method of claim 17 wherein the first location is a central location and the second location is a remote location.

21. The method of claim 17 wherein creating the menu information comprises creating button information and information regarding an action that takes place when a button is selected.

22. The method of claim 16 further comprising creating subtitles at the second location.

23. The method of claim 16 further comprising creating an audio track including a language preferred at the second location.
